(19) United States
(12) Patent Application Publication
(10) Pub. No.: US 2018/0042042 A1
(43) Pub. Date: Feb. 8, 2018

(54) TECHNIQUES FOR REPORTING DELAY BUDGETS FOR URLLC UPLINK TRANSMISSIONS

(71) Applicant: QUALCOMM Incorporated, San Diego, CA (US)

(72) Inventors: Chih Ping LI, San Diego, CA (US); Jay Kumar SUNDARARAJAN, San Diego, CA (US); Hao XU, San Diego, CA (US)

(21) Appl. No.: 15/432,259

(22) Filed: Feb. 14, 2017

Related U.S. Application Data
(60) Provisional application No. 62/370,452, filed on Aug. 3, 2016.

(51) Int. Cl. H04W 72/12; H04L 29/08; H04L 1/18; H04W 72/14

(52) U.S. Cl. CPC H04W 72/1284; H04W 72/1268; H04W 72/14; H04L 69/321; H04W 72/1242; H04W 72/1221; H04L 1/1812

(57) ABSTRACT

A method and apparatus for reporting delay budgets for Ultra-Reliable Low-Latency Communications (URLLC) uplink transmissions during wireless communications are described. The method and apparatus include receiving one or more URLLC data packets at a medium access control (MAC) buffer of a user equipment (UE), the one or more URLLC data packets scheduled for transmission to a network entity. The method and apparatus include determining a delay budget for the one or more URLLC data packets at the MAC buffer, the delay budget including information corresponding to an expiration of a transmission deadline. The method and apparatus include transmitting the delay budget to the network entity to allocate resources on an uplink data channel such that transmissions of the one or more URLLC data packets from the UE to the network entity satisfy a reliability threshold.

### CLAIM OF PRIORITY UNDER 35 U.SC. §119

The present application for patent claims priority to U.S. Provisional Application No. 62/370,452 entitled “TECHNIQUES FOR REPORTING DELAY BUDGETS FOR URLLC UPLINK TRANSMISSIONS” filed Aug. 3, 2016, which is assigned to the assignee hereof and hereby expressly incorporated by reference herein.

### BACKGROUND

Aspects of this disclosure relate generally to telecommunications, and more particularly to techniques for reporting delay budgets for Ultra-Reliable Low-Latency Communications (URLLC) uplink transmissions during wireless communications.

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems.

These multiple access technologies have been adopted in various telecommunication standards to provide a common protocol that enables different wireless devices to communicate on a municipal, national, regional, and even global level. For example, fifth generation (5G) NR (new radio) communications technology is envisaged to expand and support diverse usage scenarios and applications with respect to current mobile network generations. In an aspect, 5G communications technology includes enhanced mobile broadband addressing human-centric use cases for access to multimedia content, services and data; URLLC with strict requirements, especially in terms of latency and reliability; and massive machine type communications for a very large number of connected devices and typically transmitting a relatively low volume of non-delay-sensitive information. However, as the demand for mobile broadband access continues to increase, there exists a need for further improvements in 5G communications technology and beyond. Preferably, these improvements should be applicable to other multi-access technologies and the telecommunication standards that employ these technologies.

Techniques are needed to provide efficient and improved process for reporting delay budgets for URLLC uplink transmissions during wireless communications. In certain instances, as the next generation of wireless communications come into existence, specific latency and reliability requirements are needed to be met in order to ensure adequate levels of wireless communications. Thus, improvements in reporting delay budgets for URLLC uplink transmissions during wireless communication are desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with an aspect, a method includes reporting delay budgets for URLLC uplink transmissions during wireless communications. The described aspects include receiving one or more URLLC data packets at a medium access control (MAC) buffer of a user equipment (UE), the one or more URLLC data packets scheduled for transmission to a network entity. The described aspects further include determining a delay budget for the one or more URLLC data packets at the MAC buffer with the delay budget including information corresponding to an expiration of a transmission deadline. The described aspects further include transmitting the delay budget to the network entity to allocate resources on an uplink data channel such that transmissions of the one or more URLLC data packets from the UE to the network entity satisfy a reliability threshold.

In another aspect, an apparatus for reporting delay budgets for URLLC uplink transmissions during wireless communications may include a transceiver, a memory; and at least one processor coupled to the memory and configured to receive one or more URLLC data packets at a MAC buffer of a UE, the one or more URLLC data packets scheduled for transmission to a network entity. The described aspects further determine a delay budget for the one or more URLLC data packets at the MAC buffer with the delay budget including information corresponding to an expiration of a transmission deadline. The described aspects further transmit the delay budget to the network entity to allocate resources on an uplink data channel such that transmissions of the one or more URLLC data packets from the UE to the network entity satisfy a reliability threshold.

In another aspect, a computer-readable medium may store computer executable code for reporting delay budgets for URLLC uplink transmissions during wireless communications. The described aspects include code for receiving one or more URLLC data packets at a MAC buffer of a UE with the one or more URLLC data packets being scheduled for transmission to a network entity. The described aspects further include code for determining a delay budget for the one or more URLLC data packets at the MAC buffer with the delay budget including information corresponding to an expiration of a transmission deadline. The described aspects further include code for transmitting the delay budget to the network entity to allocate resources on an uplink data channel such that transmissions of the one or more URLLC data packets from the UE to the network entity satisfy a reliability threshold.

In another aspect, an apparatus for reporting delay budgets for URLLC uplink transmissions during wireless communications is described. The described aspects include means for receiving one or more URLLC data packets at a MAC buffer of a UE with the one or more URLLC data packets being scheduled for transmission to a network entity. The described aspects further include means for determining a delay budget for the one or more URLLC data packets at the MAC buffer with the delay budget including information corresponding to an expiration of a transmission deadline. The described aspects further include means for transmitting the delay budget to the network entity to allocate resources on an uplink data channel such that transmissions of the one or more URLLC data packets from the UE to the network entity satisfy a reliability threshold.

Various aspects and features of the disclosure are described in further detail below with reference to various examples thereof as shown in the accompanying drawings. While the present disclosure is described below with reference to various examples, it should be understood that the present disclosure is not limited thereto. Those of ordinary skill in the art having access to the teachings herein will recognize additional implementations, modifications, and examples, as well as other fields of use, which are within the scope of the present disclosure as described herein, and with respect to which the present disclosure may be of significant utility.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout, where dashed lines may indicate optional components or actions, and wherein:

FIG. 1 is a schematic diagram of a communication network including an aspect of an uplink determination component during wireless communications in accordance with various aspects of the present disclosure.

FIG. 2 is flow diagram illustrating an example method of reporting delay budgets for URLLC uplink transmissions during wireless communications in accordance with various aspects of the present disclosure.

FIG. 3 is a diagram of an example MAC buffer used for reporting delay budgets for URLLC uplink transmissions during wireless communications in accordance with various aspects of the present disclosure.

FIG. 4 is a data flow diagram illustrating the data flow between different means/components in an exemplary apparatus including an uplink determination component for reporting delay budgets for URLLC uplink transmissions during wireless communications in accordance with various aspects of the present disclosure.

FIG. 5 is a diagram illustrating an example of a hardware implementation for an apparatus employing a processing system including an uplink determination component for reporting delay budgets for URLLC uplink transmissions during wireless communications in accordance with various aspects of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts. In an aspect, the term “component” as used herein may be one of the parts that make up a system, may be hardware or software, and may be divided into other components.

The present aspects generally relate to reporting delay budgets for URLLC uplink transmissions during wireless communications. With regard to URLLC, the user plane latency is defined as successful delivery of application layer packet from layer 2/3 service data unit (SDU) ingress point to layer 2/3 SDU egress point through radio interface. In an example, for URLLC, the target for user plane average latency is 0.5 ms for uplink communications and 0.5 ms for downlink communications. Reliability is defined as the successful probability of transmitting a number of bytes within 1 ms, which is the time to deliver a small packet from protocol layer 2/3 SDU ingress point to egress point, at a certain channel quality. Specifically, for example, the requirement for URLLC is 1-10⁻⁵ within 1 ms for the number of bytes (e.g. 20 bytes) with a user plane latency of 1 ms.

Specifically, with regard to the latency requirement for URLLC, a UE is required to transmit the data packets before a transmission deadline. In an example, the transmission deadline may correspond to a time instant by which the network entity must successfully receive the transmission of a data packet from a UE. Once the transmission deadline expires, the data packet may not be of use and cannot be successfully received. Each URLLC data packet is provided with enough resources (e.g., bandwidth) in each Hybrid Access Repeat Request (HARQ) transmission to satisfy a maximum Block Error Rate (BLER) before the expiration of a transmission deadline. For a URLLC data packet that is ready to be scheduled on the uplink data channel (e.g., when the URLLC data packet reaches the head of a buffer at the UE), the allocated resources for a HARQ transmission and/or subsequent HARQ retransmissions depends on the remaining delay budget of the packet. Therefore, a need exists for a communication design that fulfills the latency and reliability requirements for URLLC.

Accordingly, in some aspects, the present methods and apparatuses may provide an efficient solution, as compared to current solutions, by reporting delay budgets for URLLC uplink transmissions during wireless communications. In other words, in the present aspects, a UE that is operating in an URLLC mode may notify a network entity of the budget delays in order to satisfy latency and reliability requirements. As such, the present aspects provide one or more mechanisms for receiving one or more URLLC data packets at a MAC buffer of a UE, the one or more URLLC data packets scheduled for transmission to a network entity. Moreover, the present aspects also provide one or more mechanisms for determining a delay budget for the one or more URLLC data packets at the MAC buffer, the delay budget including information corresponding to an expiration of a transmission deadline. Additionally, the present aspects also provide one or more mechanisms for transmitting the delay budget to the network entity to configure a network entity scheduler in allocating resources on an uplink channel such that transmissions from the UE to the network entity satisfy a reliability threshold.

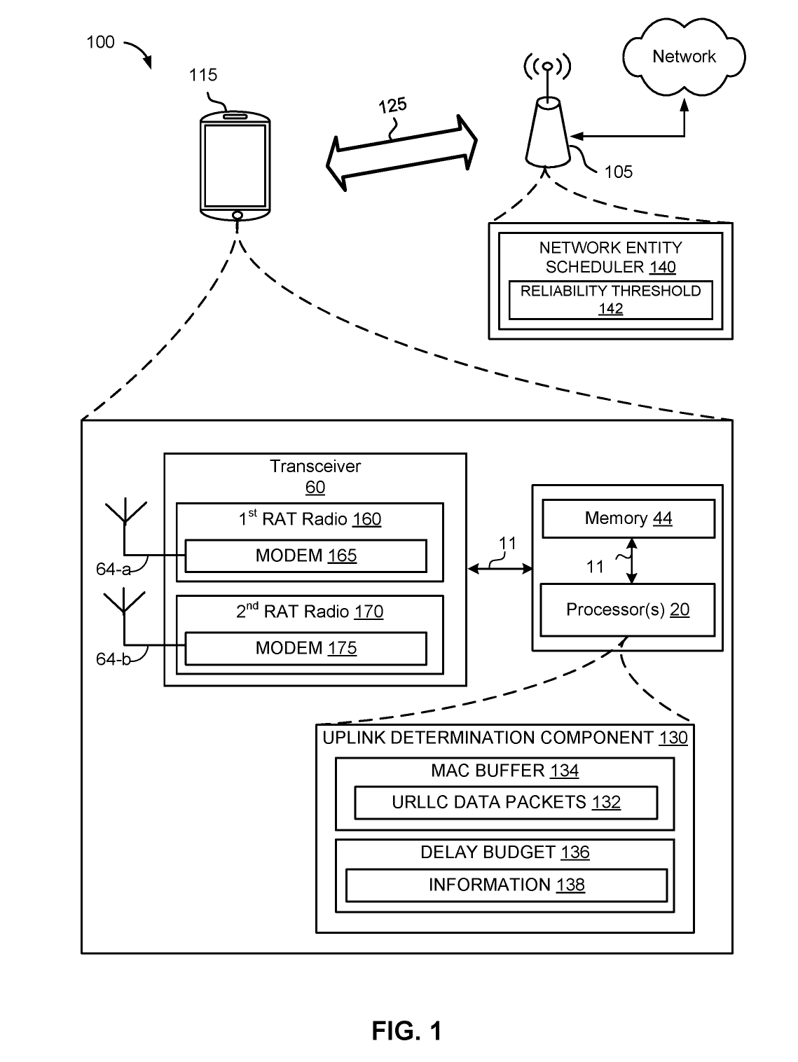

Referring to FIG. 1, in an aspect, a wireless communication system 100 includes at least one user equipment (UE) 115 in communication coverage of at least network entities 105. The UE 115 may communicate with network via network entity 105. In an example, UE 115 may transmit and/or receive wireless communication to and/or from network entity 105 via one or more communication channels 125, which may include an uplink communication channel (or simply uplink channel) and a downlink communication channel (or simply downlink channel), such as but not limited to an uplink data channel and/or downlink data channel. Such wireless communications may include, but are not limited to, data, audio and/or video information.

In accordance with the present disclosure, UE 115 may include a memory 44, one or more processors 20 and a transceiver 60. The memory, one or more processors 20 and the transceiver 60 may communicate internally via a bus 11. In some examples, the memory 44 and the one or more processors 20 may be part of the same hardware component (e.g., may be part of a same board, module, or integrated circuit). Alternatively, the memory 44 and the one or more processors 20 may be separate components that may act in conjunction with one another. In some aspects, the bus 11 may be a communication system that transfers data between multiple components and subcomponents of the UE 115. In some examples, the one or more processors 20 may include any one or combination of modem processor, baseband processor, digital signal processor and/or transmit processor. Additionally or alternatively, the one or more processors 20 may include an uplink determination component 130 for carrying out one or more methods or procedures described herein. The uplink determination component 130 may comprise hardware, firmware, and/or software and may be configured to execute code or perform instructions stored in a memory (e.g., a computer-readable storage medium).

In some examples, the UE 115 may include the memory 44, such as for storing data used herein and/or local versions of applications or communication with uplink determination component 130 and/or one or more of its subcomponents being executed by the one or more processors 20. Memory 44 can include any type of computer-readable medium usable by a computer or processor 20, such as random access memory (RAM), read only memory (ROM), tapes, magnetic discs, optical discs, volatile memory, non-volatile memory, and any combination thereof. In an aspect, for example, memory 44 may be a computer-readable storage medium (e.g., a non-transitory medium) that stores one or more computer-executable codes defining uplink determination component 130 and/or one or more of its subcomponents, and/or data associated therewith, when UE 115 is operating processor 20 to execute uplink determination component 130 and/or one or more of its subcomponents. In some examples, the UE 115 may further include a transceiver 60 for transmitting and/or receiving one or more data and control signals to/from the network via network entity 105. The transceiver 60 may comprise hardware, firmware, and/or software and may be configured to execute code or perform instructions stored in a memory (e.g., a computer-readable storage medium). The transceiver 60 may include a 1^{st} radio access technology (RAT) radio 160 (e.g. UMTS/WCDMA, LTE-A, WLAN, Bluetooth, WSAN-FA) comprising a modem 165, and a 2^{nd} RAT radio 170 (e.g., 5G) comprising a modem 175. The 1^{st} RAT radio 160 and 2^{nd} RAT radio 170 may utilize one or more antennas 64 for transmitting signals to and receiving signals from the network entity 105.

In a blended radio environment such as system 100, different RATs may make use of different channels at different times. Because different RATs are sharing the spectrum and operating partly independently of others, access to one channel may not imply access to another channel. Accordingly, a device capable of transmitting using multiple channels may need to determine whether each channel is available before transmitting. In order to increase bandwidth and throughput, it may be beneficial in some situations to wait for an additional channel to become available rather than transmitting using currently available channel(s).

In some examples, the uplink determination component 130 may be configured to report delay budgets for URLLC uplink transmissions during wireless communications. In an aspect, for example, UE 115 may perform a random access procedure to connect with the network entity 105. Once UE 115 has connected with network entity 105 and has access to the network, UE 115 may transition to a URLLC mode. In an instance, UE 115 may transition to the URLLC mode immediately in response to connecting with the network entity 105. In another instance, UE 115 may transition to the URLLC mode at any later time after connecting with the network entity 105. Once in URLLC mode, UE 115 may execute uplink determination component 130 to report budget delays to the network entity 105. For example, uplink determination component 130 may receive one or more URLLC data packets 132 at a MAC buffer 134 of a UE 115. In an example, the one or more URLLC data packets 132 are scheduled for transmission to a network entity 105.

In an aspect, UE 115 may execute uplink determination component 130 to determine a delay budget 136 for the one or more URLLC data packets 132. For example, the delay budget 136 includes information 138 corresponding to an expiration of a transmission deadline. As noted herein, each URLLC data packet 132 is provided with enough resources in each HARQ transmission to satisfy a maximum BLER before the expiration of a transmission deadline. For a URLLC data packet 132 that is ready to be scheduled on the uplink data channel (e.g., when the URLLC data packet reaches the head of a MAC buffer 134 at the UE 115), the allocated resources for a HARQ transmission and/or subsequent HARQ retransmissions depends on the remaining delay budget of the packet. Furthermore, the information 138 corresponding to the expiration of the transmission deadline may include at least one or more of an amount of time remaining until the expiration of the transmission deadline, a number of subframes remaining until the expiration of the transmission deadline, and an indication corresponding to a normal status or an urgent status for the transmission to the network entity. Moreover, in an example, uplink determination component 130 may trigger the determination of the delay budget 136. Additionally, uplink determination component 130 may be configured to determine the delay budget 136 for the one or more URLLC data packets 132 based on at least of a first packet in a queue of the MAC buffer 134, the first packet and a last packet in the queue of the MAC buffer 134, or all of the one or more URLLC data packets in the queue of the MAC buffer 134. In a further example, uplink determination component 130 may the delay budget 136 for the one or more URLLC data packets 132 periodically.

In an aspect, UE 115 and/or uplink determination component 130 may execute transceiver 60 to transmit the delay budget 136 to the network entity 105 to configure network entity scheduler 140 in allocating resources on an uplink channel (of communication channel 125) such that transmissions from the UE 115 to the network entity 105 satisfy a reliability threshold 142. UE 115 and/or uplink determination component 130 may execute transceiver 60 to transmit the delay budget 136 in a plurality of aspects.

In an aspect, uplink determination component 130 may determine whether a capacity of an uplink shared channel (UL-SCH) satisfies a maximum capacity threshold. In other words, uplink determination component 130 may determining whether the channel has enough room for the delay budget 136, the UL-SCH corresponding to a data channel. Subsequently, UE 115 and/or uplink determination component 130 may execute transceiver 60 to transmit a buffer status report (BSR) including the delay budget 136 over the UL-SCH to the network entity 105.

In another aspect, UE 115 and/or uplink determination component 130 may execute transceiver 60 to transmit a scheduling request on an uplink control channel to the network entity 105. In an example, UE 115 and/or uplink determination component 130 may execute transceiver 60 to transmit a one-bit scheduling request on an uplink control channel (of communication channel 125) to the network entity 105. The one-bit scheduling request may indicate the delay budget 136 and a payload size of each of the one or more URLLC data packets 132 based on a downlink grant previously received by the UE 115 from the network entity 105. The downlink grant may include the payload size and an original delay budget determined by the network entity 105. In an instance, the one-bit scheduling request is included within a MAC Service Data Unit (SDU) header.

In another example, UE 115 and/or uplink determination component 130 may execute transceiver 60 to transmit a multi-bit scheduling request on an uplink control channel (of communication channel 125) to the network entity 105. The multi-bit scheduling request may include at least the delay budget 136. In some instances, the multi-bit scheduling request indicates an entry in a look-up table of the network entity 105 corresponding to the delay budget, payload size, and/or the allocation of resources of a data packet for the UE 115. In other instances, the multi-bit scheduling request includes at least one of a normal status or an urgent status for the transmission of the one or more URLLC data packets 132 to the network entity 105. In another instance, the multi-bit scheduling request includes at least one of a normal status or an urgent status for the transmission of the one or more URLLC data packets to the network entity and a payload size of each of the one or more URLLC data packets. Similarly, the multi-bit scheduling request may be included within a MAC SDU header.

In another aspect of the reliability threshold, the transmissions from the UE to the network entity correspond to at least one of hybrid automatic repeat request (HARQ) transmissions or HARQ retransmissions. Moreover, UE 115 and/or uplink determination component 130 may execute transceiver 60 to transmit the delay budget 136 to the network entity 105 in a time division duplex (TDD) based radio access technology (RAT) or a frequency division duplex (FDD) based RAT. Further, the reliability threshold 142 corresponds to a system reliability value of the UE 115. In an example, UE 115 and/or uplink determination component 130 may determine that a maximum threshold BLER is less than the reliability threshold before transmitting the delay budget 136.

A UE 115 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wearable item such as a watch or glasses, a wireless local loop (WLL) station, or the like. A UE 115 may be able to communicate with macro eNodeBs, small cell eNodeBs, relays, and the like. A UE 115 may also be able to communicate over different access networks, such as cellular or other WWAN access networks, or WLAN access networks.

Additionally, as used herein, the one or more wireless nodes, including, but not limited to, network entity 105 of wireless communication system 100, may include one or more of any type of network component, such as an access point, including a base station or node B, a relay, a peer-to-peer device, an authentication, authorization and accounting (AAA) server, a mobile switching center (MSC), a radio network controller (RNC), etc. In a further aspect, the one or more wireless serving nodes of wireless communication system 100 may include one or more small cell base stations, such as, but not limited to a femtocell, picocell, microcell, or any other base station having a relatively small transmit power or relatively small coverage area as compared to a macro base station.

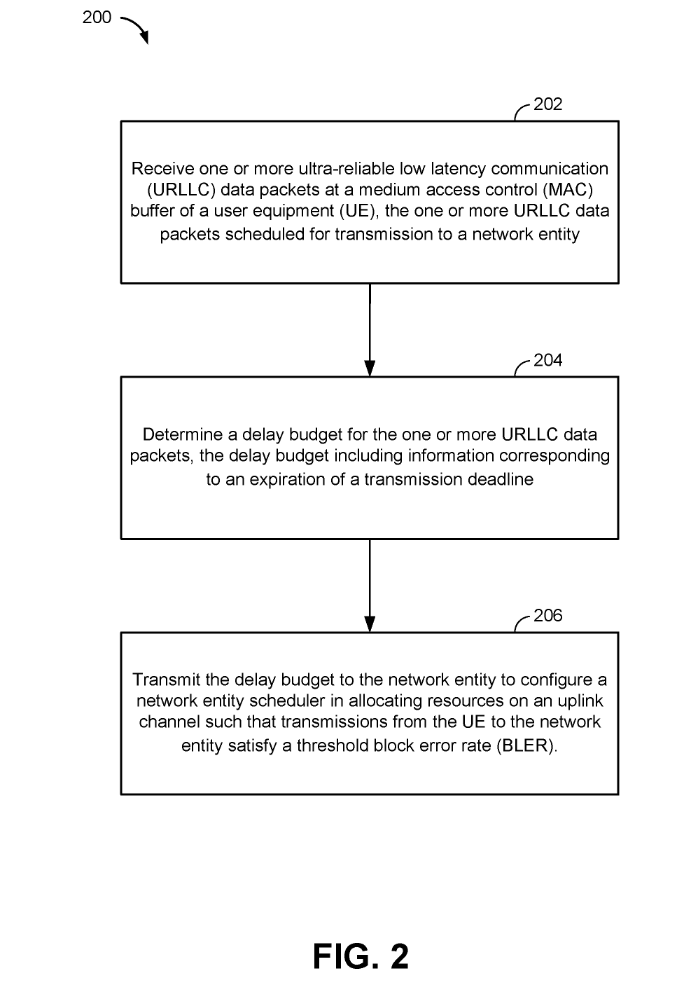

Referring to FIG. 2, an example of one or more operations and/or an example of architectural layout and components and subcomponents (FIG. 1) of an aspect of uplink determination component 130 (FIG. 1) according to the present apparatus and methods are described with reference to one or more methods and one or more components that may perform the actions of these methods. Although the operations described below are presented in a particular order and/or as being performed by an example component, it should be understood that the ordering of the actions and the components performing the actions may be varied, depending on the implementation. Also, although the uplink determination component 130 is illustrated as having a number of subcomponents, it should be understood that one or more of the illustrated subcomponent may be separate from, but in communication with, the uplink determination component 130 and/or each other. Moreover, it should be understood that the following actions or components described with respect to the uplink determination component 130 and/or its subcomponents may be performed by a specially-programmed processor, a processor executing specially-programmed software or computer-readable media, or by any other combination of a hardware component and/or a software component specially configured for performing the described actions or components.

In an aspect, at block 202, method 200 includes receiving one or more URLLC data packets at a MAC buffer of a UE, the one or more URLLC data packets scheduled for transmission to a network entity. In an aspect, for example, UE 115 may execute transceiver 60 and/or uplink determination component 130 (FIG. 1) to receive one or more URLLC data packets 132 at a MAC buffer 134 of a UE 115, the one or more URLLC data packets 132 scheduled for transmission to a network entity 105.

In an aspect, at block 204, method 200 includes determining a delay budget for the one or more URLLC data packets, the delay budget including information corresponding to an expiration of a transmission deadline. In an aspect, for example, UE 115 may execute transceiver 60 and/or uplink determination component 130 (FIG. 1) to determine a delay budget 136 for the one or more URLLC data packets at the MAC buffer 134, the delay budget 136 including information 138 corresponding to an expiration of a transmission deadline.

In an aspect, at block 206, method 200 includes transmitting the delay budget to the network entity to allocate resources on an uplink data channel such that transmissions of the one or more URLLC data packets from the UE to the network entity satisfy a reliability threshold. In an aspect, for example, UE 115 and/or uplink determination component 130 (FIG. 1) may execute transceiver 60 (and more specifically 2^{nd} RAT radio 170 (e.g., 5G)) to transmit the delay budget 136 to the network entity 105 to configure a network entity scheduler 140 in allocating resources on an uplink channel 125 such that transmissions of the one or more URLLC data packets 132 from the UE 115 to the network entity 105 satisfy a reliability threshold 142.

In an example, method 200 may include UE 115 executing uplink determination component 130 (FIG. 1) to determine whether a capacity of an UL-SCH satisfies a maximum capacity threshold, the UL-SCH corresponding to a data channel. Subsequently, UE 115 may execute transceiver 60 to transmit a BSR including the delay budget over the UL-SCH to the network entity 105.

In another example, method 200 may include UE 115 executing transceiver 60 to transmit a one-bit scheduling request on an uplink control channel to the network entity 105, the scheduling request indicating at least one of a normal status or an urgent status for the transmission to the network entity 105. The one-bit scheduling request may indicate the delay budget 136 and a payload size of each of the one or more URLLC data packets 132 based on a downlink grant previously received by the UE 115 from the network entity 105. The downlink grant may include the payload size and an original delay budget determined by the network entity 105. In an instance, the one-bit scheduling request is included within a MAC SDU header.

In a further example, method 200 may include UE 115 executing transceiver 60 to transmit a multi-bit scheduling request on an uplink control channel (of communication channel 125) to the network entity 105. The multi-bit scheduling request may include at least the delay budget 136. In some instances, the multi-bit scheduling request indicates an entry in a look-up table of the network entity 105 corresponding to the delay budget, payload size, and/or the allocation of resources of a data packet for the UE 115. In other instances, the multi-bit scheduling request includes at least one of a normal status or an urgent status for the transmission of the one or more URLLC data packets 132 to the network entity 105. In another instance, the multi-bit scheduling request includes at least one of a normal status or an urgent status for the transmission of the one or more URLLC data packets to the network entity and a payload size of each of the one or more URLLC data packets.

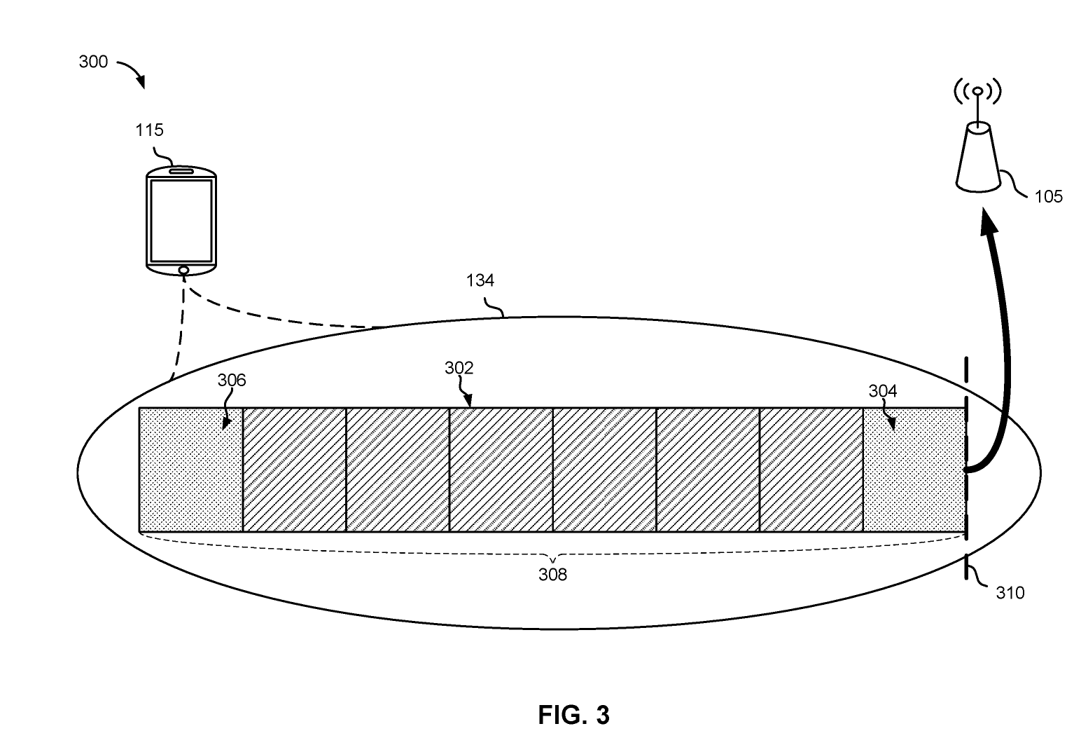

FIG. 3 illustrates a conceptual diagram 300 of a MAC buffer used for reporting delay budgets for URLLC uplink transmissions during wireless communications. For example, a MAC buffer, such as MAC buffer 134, which may be the same or similar to MAC buffer 134 of FIG. 1, may be configured to queue one or more data packets for uplink transmits from a UE 115, which may be the same or similar to UE 115 of FIG. 1, to a network entity 105, which may be the same or similar to network entity 105 of FIG. 1. The MAC buffer 134 may be included and/or operated on processor(s) 20 and/or uplink determination component 130. In an aspect, MAC buffer 134 may include a queue 302, which may include one or more data packets, such as one or more URLLC data packets. As shown in diagram 300, queue 302 includes eight (8) data packets constituting all of the one or more URLLC data packets 308, including a first packet 304 and a last packet 306. In an example, once one of the data packets, such as first packet 304, reaches the head-of-line 310 of the queue 302, that data packet is transmitted to the network entity 105 on an uplink data channel.

In an aspect, UE 115 may determine the delay budget for the one or more URLLC data packets based on at least a first packet 304 in the queue 302 of the MAC buffer 134, a first packet 304 and a last packet 306 in the queue 302 of the MAC buffer 134, or all of the one or more URLLC data packets 308 in the queue 302 of the MAC buffer 134. For example, uplink determination component 130 (FIG. 1) may be configured to determine the delay budget for the first packet 304 once it reaches the head-of-line 310 of the queue 302, and subsequently transmit the first packet 304 with the delay budget to the network entity 105. In another example, uplink determination component 130 (FIG. 1) may be configured to determine the delay budget for the first packet 304 once it reaches the head-of-line 310 of the queue 302 and the last packet 306, and subsequently transmit the first packet 304 and the last packet 306 with the delay budget to the network entity 105. In a further example, uplink determination component 130 (FIG. 1) may be configured to determine the delay budget for all of the one or more URLLC data packets 308 of the queue 302, and subsequently transmit each of the one or more URLLC data packets 308 with the delay budget to the network entity 105.

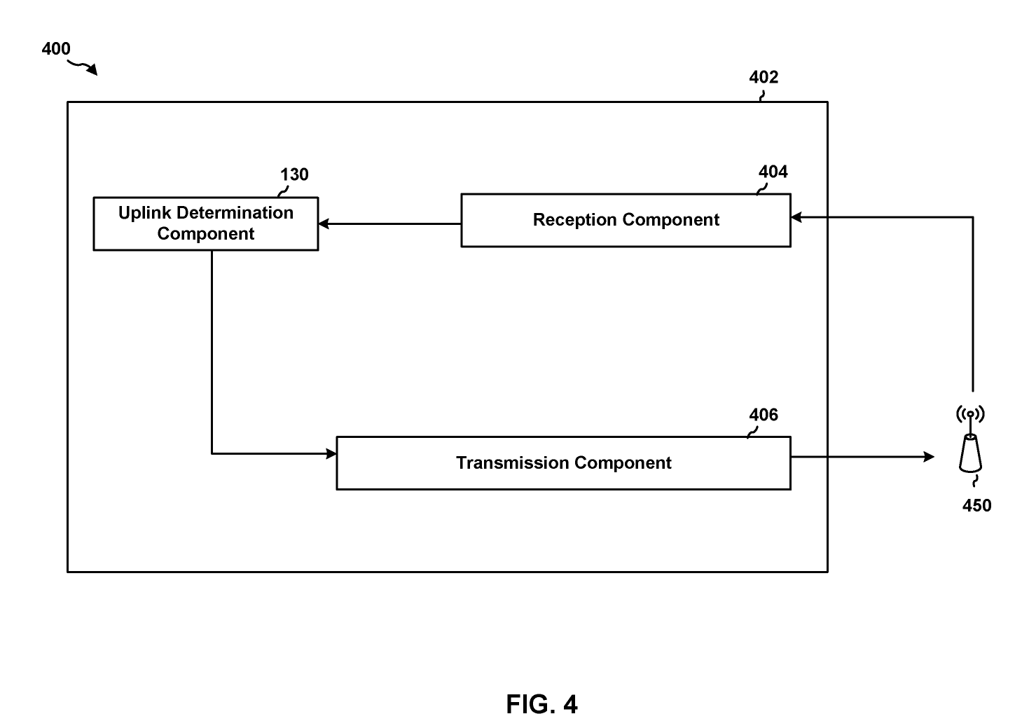

FIG. 4 is a data flow diagram 400 illustrating the data flow between different means/components in an exemplary apparatus 402 that includes uplink determination component 130, which may be the same as or similar to uplink determination component 130 for reporting delay budgets for URLLC uplink transmissions during wireless communications. The apparatus 402 may be a UE, which may include UE 115 of FIG. 1. The apparatus 402 includes a reception component 404 that receives one or more URLLC data packets 132 at a MAC buffer 134 of a UE 115 with the one or more URLLC data packets 132 scheduled for transmission to a network entity 450. The apparatus 402 includes a uplink determination component 130 that determines a delay budget 136 for the one or more URLLC data packets 132 at the MAC buffer 134, the delay budget 136 including information 138 corresponding to an expiration of a transmission deadline. The apparatus 402 includes an transmission component 406 that transmits the delay budget 136 to the network entity 105 to allocate resources on an uplink data channel such that transmissions of the one or more URLLC data packets 132 from the UE 115 to the network entity 450 satisfy a reliability threshold.

The apparatus 402 may include additional components that perform each of the blocks of the algorithm in the aforementioned flowchart of FIG. 2. As such, each block in the aforementioned flowchart of FIG. 2 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

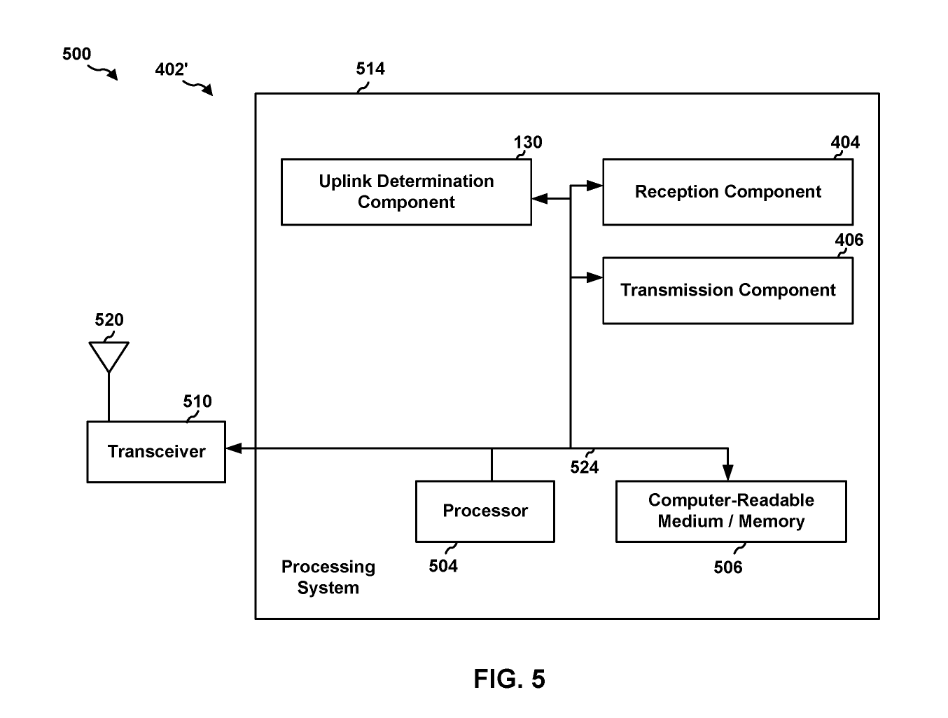

FIG. 5 is a diagram 500 illustrating an example of a hardware implementation for an apparatus 402′ employing a processing system 514 that includes uplink determination component 130 (FIG. 1), which may be the same as or similar to uplink determination component 130 for reporting delay budgets for URLLC uplink transmissions during wireless communications. The processing system 514 may be implemented with a bus architecture, represented generally by the bus 524. The bus 524 may include any number of interconnecting buses and bridges depending on the specific application of the processing system 514 and the overall design constraints. The bus 524 links together various circuits including one or more processors and/or hardware components, represented by the processor 504, the components 130, 404, and 406, and the computer-readable medium/memory 506. The bus 524 may also link various other circuits such as timing sources, peripherals, voltage regulators, and power management circuits, which are well known in the art, and therefore, will not be described any further.

The processing system 514 may be coupled to a transceiver 510. The transceiver 510 is coupled to one or more antennas 520. The transceiver 510 provides a means for communicating with various other apparatus over a transmission medium. The transceiver 510 receives a signal from the one or more antennas 520, extracts information from the received signal, and provides the extracted information to the processing system 514, specifically the reception component 404. In addition, the transceiver 510 receives information from the processing system 514, specifically the transmission component 406, and based on the received information, generates a signal to be applied to the one or more antennas 520. The processing system 514 includes a processor 504 coupled to a computer-readable medium/memory 506. The processor 504 is responsible for general processing, including the execution of software stored on the computer-readable medium/memory 506. The software, when executed by the processor 504, causes the processing system 514 to perform the various functions described supra for any particular apparatus. The computer-readable medium/memory 506 may also be used for storing data that is manipulated by the processor 504 when executing software. The processing system 514 further includes at least one of the components 130, 404, and 406. The components may be software components running in the processor 504, resident/stored in the computer readable medium/memory 506, one or more hardware components coupled to the processor 504, or some combination thereof.

In one configuration, the apparatus 402/402′ for wireless communication includes means for receiving one or more URLLC data packets at a MAC buffer of a UE, the one or more URLLC data packets scheduled for transmission to a network entity, means for determining a delay budget for the one or more URLLC data packets at the MAC buffer, the delay budget including information corresponding to an expiration of a transmission deadline and means for transmitting the delay budget to the network entity to allocate resources on an uplink data channel such that transmissions of the one or more URLLC data packets from the UE to the network entity satisfy a reliability threshold. The aforementioned means may be one or more of the aforementioned components of the apparatus 402 and/or the processing system 514 of the apparatus 402′ configured to perform the functions recited by the aforementioned means.

In some aspects, an apparatus or any component of an apparatus may be configured to (or operable to or adapted to) provide functionality as taught herein. This may be achieved, for example: by manufacturing (e.g., fabricating) the apparatus or component so that it will provide the functionality; by programming the apparatus or component so that it will provide the functionality; or through the use of some other suitable implementation technique. As one example, an integrated circuit may be fabricated to provide the requisite functionality. As another example, an integrated circuit may be fabricated to support the requisite functionality and then configured (e.g., via programming) to provide the requisite functionality. As yet another example, a processor circuit may execute code to provide the requisite functionality.

It should be understood that any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be employed there or that the first element must precede the second element in some manner. Also, unless stated otherwise a set of elements may comprise one or more elements. In addition, terminology of the form “at least one of A, B, or C” or “one or more of A, B, or C” or “at least one of the group consisting of A, B, and C” used in the description or the claims means “A or B or C or any combination of these elements.” For example, this terminology may include A, or B, or C, or A and B, or A and C, or A and B and C, or 2A, or 2B, or 2C, and so on.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The methods, sequences and/or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

Accordingly, an aspect of the disclosure can include a computer readable medium embodying a method for dynamic bandwidth management for transmissions in unlicensed spectrum. Accordingly, the disclosure is not limited to the illustrated examples.

While the foregoing disclosure shows illustrative aspects, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although certain aspects may be described or claimed in the singular, the plural is contemplated unless limitation to the singular is explicitly stated.

What is claimed is:

1. A method of communications, comprising:
receiving one or more ultra-reliable low latency communication (URLLC) data packets at a medium access control (MAC) buffer of a user equipment (UE), the one or more URLLC data packets scheduled for transmission to a network entity;
determining a delay budget for the one or more URLLC data packets at the MAC buffer, the delay budget including information corresponding to an expiration of a transmission deadline; and
transmitting the delay budget to the network entity to allocate resources on an uplink data channel such that transmissions of the one or more URLLC data packets from the UE to the network entity satisfy a reliability threshold.

2. The method of claim 1, wherein transmitting the delay budget to the network entity comprises:
transmitting a one-bit scheduling request on an uplink control channel to the network entity, the one-bit scheduling request indicating the delay budget and a payload size of each of the one or more URLLC data packets based on a downlink grant previously received by the UE from the network entity, the downlink grant including the payload size and original delay budget.

3. The method of claim 2, wherein the one-bit scheduling request is included within a MAC Service Data Unit (SDU) header.

4. The method of claim 1, wherein transmitting the delay budget to the network entity comprises:
transmitting a multi-bit scheduling request on an uplink control channel to the network entity, the multi-bit scheduling request including at least the delay budget.

5. The method of claim 4, wherein the multi-bit scheduling request indicates an entry in a look-up table of the network entity corresponding to the delay budget, payload size, and/or the allocation of resources of a data packet for the UE.

6. The method of claim 4, wherein the multi-bit scheduling request includes at least one of a normal status or an urgent status for the transmission of the one or more URLLC data packets to the network entity.

7. The method of claim 4, wherein the multi-bit scheduling request includes at least one of a normal status or an urgent status for the transmission of the one or more URLLC data packets to the network entity and a payload size of each of the one or more URLLC data packets.

8. The method of claim 1, wherein the information corresponding to the expiration of the transmission deadline comprises one or more of an amount of time remaining until the expiration of the transmission deadline, a number of subframes remaining until the expiration of the transmission deadline, an indication corresponding to a normal status or an urgent status for the transmission of the one or more URLLC data packets to the network entity, or a total number of the one or more URLLC data packets in the MAC buffer of the UE.

9. The method of claim 1, wherein receiving the one or more URLLC data packets at the MAC buffer of the UE further comprises receiving the one or more URLLC data packets at a queue of the MAC buffer of the UE,
wherein determining the delay budget for the one or more URLLC data packets further comprises determining the delay budget for the one or more URLLC data packets based on at least a first packet in the queue of the MAC buffer, a first packet and a last packet in the queue of the MAC buffer, or all of the one or more URLLC data packets in the queue of the MAC buffer, and
wherein the first packet and the last packet each correspond to one of the one or more URLLC data packets in the queue of the MAC buffer.

10. The method of claim 1, wherein determining the delay budget for the one or more URLLC data packets further comprises determining the delay budget for the one or more URLLC data packets periodically, and
wherein transmitting the delay budget to the network entity further comprises transmitting the delay budget to the network entity periodically.

11. The method of claim 1, wherein the transmission of the one or more URLLC data packets from the UE to the network entity correspond to at least one of hybrid automatic repeat request (HARQ) transmissions or HARQ retransmissions.

12. The method of claim 1, wherein transmitting the delay budget to the network entity further comprises transmitting the delay budget to the network entity in a time division duplex (TDD) based radio access technology (RAT) or a frequency division duplex (FDD) based RAT.

13. The method of claim 1, wherein transmitting the delay budget to the network entity further comprising transmitting the delay budget to the network entity to configure a network entity scheduler.

14. An apparatus for wireless communications, comprising:
means for receiving one or more ultra-reliable low latency communication (URLLC) data packets at a medium access control (MAC) buffer of a user equipment (UE), the one or more URLLC data packets scheduled for transmission to a network entity;
means for determining a delay budget for the one or more URLLC data packets at the MAC buffer, the delay budget including information corresponding to an expiration of a transmission deadline; and
means for transmitting the delay budget to the network entity to allocate resources on an uplink data channel such that transmissions of the one or more URLLC data packets from the UE to the network entity satisfy a reliability threshold.

15. A computer-readable medium storing computer executable code for wireless communications, comprising:
code for receiving one or more ultra-reliable low latency communication (URLLC) data packets at a medium access control (MAC) buffer of a user equipment (UE), the one or more URLLC data packets scheduled for transmission to a network entity;
code for determining a delay budget for the one or more URLLC data packets at the MAC buffer, the delay budget including information corresponding to an expiration of a transmission deadline; and
code for transmitting the delay budget to the network entity to allocate resources on an uplink data channel such that transmissions of the one or more URLLC data packets from the UE to the network entity satisfy a reliability threshold.

16. An apparatus for wireless communications, comprising:
a transceiver;
a memory configured to store data; and
one or more processors communicatively coupled with the transceiver and the memory, the one or more processors and the memory being configured to:
receive one or more ultra-reliable low latency communication (URLLC) data packets at a medium access control (MAC) buffer of a user equipment (UE), the one or more URLLC data packets scheduled for transmission to a network entity;
determine a delay budget for the one or more URLLC data packets at the MAC buffer, the delay budget including information corresponding to an expiration of a transmission deadline; and
transmit the delay budget to the network entity to allocate resources on an uplink data channel such that transmissions of the one or more URLLC data packets from the UE to the network entity satisfy a reliability threshold.

17. The apparatus of claim 16, wherein the one or more processors are configured to transmit the delay budget to the network entity and are further configured to:
transmit a one-bit scheduling request on an uplink control channel to the network entity, the one-bit scheduling request indicating the delay budget and a payload size of each of the one or more URLLC data packets based on a downlink grant previously received by the UE from the network entity, the downlink grant including the payload size and original delay budget, wherein the one-bit scheduling request is included within a MAC Service Data Unit (SDU) header.

18. The apparatus of claim 16, wherein transmitting the delay budget to the network entity comprises:
transmitting a multi-bit scheduling request on an uplink control channel to the network entity, the multi-bit scheduling request including at least the delay budget.

19. The apparatus of claim 18, wherein the multi-bit scheduling request indicates an entry in a look-up table of the network entity corresponding to the delay budget, payload size, and/or the allocation of resources of a data packet for the UE.

20. The apparatus of claim 18, wherein the multi-bit scheduling request includes at least one of a normal status or an urgent status for the transmission of the one or more URLLC data packets to the network entity and a payload size of each of the one or more URLLC data packets.
